(19) United States
(12) Patent Application Publication
(10) Pub. No.: US 2007/0288266 A1
(43) Pub. Date: Dec. 13, 2007

(54) System and methods for chronic disease management and health assessment

(76) Inventors: Suzanne Sysko, Baltimore, MD (US); Yves Nordmann, Zurich (CH); Shimon Zilbershlag, Baltimore, MD (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/806,370

(22) Filed: May 31, 2007

Related U.S. Application Data
(60) Provisional application No. 60/803,790, filed on Jun. 2, 2006.

(51) Int. Cl. G06Q 50/00

(52) U.S. Cl. 705/2

(57) ABSTRACT

The systems and methods are provided to enable consistent lifestyle modifications for chronic disease management. More specifically, systems and methods are directed to performing subjective health assessments (HAs) and objective stage-of-change (SOC) status evaluations of a patient's health based on data collected from the patient. These data are collected directly from the patient via the Internet and/or portable communications devices and maintained electronically for easy access by both the patient and health care providers.

### CROSS REFERENCE TO RELATED APPLICATIONS

This application claims the benefit of priority to U.S. Provisional Patent Application No. 60/803,790, filed Jun. 2, 2006, the entire contents of which are hereby incorporated by reference in their entirety.

### BACKGROUND

The present invention relates to a system and methods for chronic disease management. More specifically, embodiments consistent with the present invention is directed to performing subjective health assessments (HAs) and objective stage-of-change (SOC) status evaluations of a patient's health based on data maybe collected from the patient. These data are collected directly from the patient via the Internet and/or portable communications devices and maintained electronically for easy access by both the patient and health care providers.

Chronic diseases impose an enormous, worldwide financial and societal burden. According to the Centers for Disease Control and Prevention (CDC), chronic diseases today account for 70% of the deaths of all Americans and 75% of the country's annual health care costs.

Developing a chronic disease is not an inevitable consequence of aging. In many cases, the origin of chronic diseases is grounded in health-damaging behaviors practiced by people every day for much of their lives. However, evidence indicates that, with education and support, people can and will take charge of their health through lifestyle modifications. Prevention and treatment of chronic diseases through lifestyle modifications is considered a very cost-effective, affordable and sustainable course of action to cope with the chronic disease epidemic. Thus, there is a need for better personal health management as a vehicle to reduce the dramatic rise and effects of chronic diseases and their annual health care costs.

Risk factors and behaviors should be assessed before lifestyle modifications can be successfully implemented. Health assessments (HA), obtained by collecting and analyzing objective data (e.g., blood glucose, blood pressure, heart rate) indicating risk factors and behaviors have been used in the background art as a means of measuring a patient's current health and to identify factors and behaviors that indicate a health risk. Once collected and analyzed, these factors/behaviors are cited to the patient as needing improvement and goals are set to obtain parameters within established standards for good health. However, the background art approaches that involve merely setting goals without ascertaining the patient's attitudes toward a treatment regimen have often been ineffective.

Thus, it may be desirable to consider the patient's readiness to change, in order to fully understand an individual's health state and to design an appropriate and tailored action plan for care. The stages-of-change (SOC) model has been used in the past to conceptualize the process of intentional behavior change. “Stage-based” approaches of the background art, derived from the SOC model have demonstrated widespread utility and effectiveness.

However, there are several key deterrents to the practical application of the HA and SOC theoretical models discussed above. Recent studies have concluded that one (1) minute is the realistic average amount of time a primary healthcare provider can devote to advising a patient on chronic disease prevention issues during a typical office visit. Thus, often there is not enough time devoted to collecting data concerning physical activity, dietary habits of the patient and their stage in the SOC model.

In addition, time for counseling and discussion of intervention strategies is also minimal during office visits. In the rare case when there is time to discuss lifestyle modifications, the problem of recall bias comes into play. That is, due to errors in a patient's recall, the background art methods using paper-based activity and food logs have a high degree of inaccuracy. In addition, when a patient fills out a paper questionnaire, it often becomes a static document that gets lost in the physician's file on the patient or is misplaced by the patient themselves. Further, once reviewed, this information often is not updated by the patient and has little utilization for on-going intervention and re-assessment. Thus, the use of paper to collect measurements (e.g., patient questionnaires, blood glucose log books) and the maintenance of that paper trail is often problematic.

Furthermore, some background art systems only measure one subjective parameter (e.g., blood glucose) and only give the diabetic patient feedback about these measurements (e.g., feedback on blood glucose trends using multiple data points). Though these background art systems can provide feedback to the patient via fax, e-mail, and the Internet, they are mislabeled as “diabetic control systems.” In fact, they are only blood glucose management systems and not a disease management or overall health assessment system.

Additional examples of background art include U.S. Pat. Nos. 5,200,891; 5,642,731; and 6,085,752, which generally describe portable electronic devices with visual displays that remind patients to take their medications. In particular, the '752 patent describes a device that not only stores and dispenses medicine but also enables distant monitoring of medicine used by the patient. In addition, the electronic device of the '752 patent may be programmed to provide positive reinforcement to the patient (See FIGS. 6-9 and column 3, line 50 to column 4, line 9). Moreover, alarms are also included with the device of the '752 patent to promote adherence to a treatment regimen of prescribed medications for a patient (See column 8, lines 13-24; and column 9, lines 46-55). However, these background art examples do not utilize mechanisms, such as the HA, SOC, or “5 A's” models, to take into consideration the patients readiness to change to adhere to a treatment regimen.

Therefore, there is a need in the art for: (1) better health management as a vehicle to reduce the dramatic rise and effects of chronic disease; (2) prevention and treatment of chronic diseases through practical implementation of lifestyle modifications; and (3) improved system and methods for subjective and objective health assessments to support chronic disease management.

### SUMMARY

Embodiments consistent with the present invention may include a method for managing a chronic disease in a patient. The method may comprise receiving first data and second data at a patient communication terminal, the first data being representative of the patient's physical condition and the second data being representative of the patient's readiness to modify behavior. The method may further include transmitting the first and second data over a communication channel to a disease management server, generating an output signal at the server representative of a disease treatment action based on the first and second data, transmitting the output signal over the communication channel to the patient communication terminal, and displaying the output signal at the patient communication terminal.

### BRIEF DESCRIPTION OF THE DRAWINGS

FIG. 1 shows a non-limiting example consistent with an embodiment of the present invention.

FIG. 2 illustrates an exemplary personal communication device.

FIG. 3 is a flow diagram of an exemplary embodiment of the method for chronic disease management consistent with the present invention.

FIG. 4 illustrates yet another exemplary embodiment of a method for chronic disease management of the present invention.

FIG. 5 illustrates an exemplary flow diagram of an embodiment of a method for health assessments consistent with the present invention.

FIG. 6, illustrates the initial steps of a method for diagnosing the chronic disease dyslipidemia.

FIG. 7 is an exemplary flow diagram related to the algorithm for assessing why the patient is having problems reaching the goals of the action plans.

FIG. 8 is an exemplary diagram presenting a personalized Action Plan consistent with the present invention.

### DETAILED DESCRIPTION

Embodiments consistent with the present invention may provide a system and methods for the practical implementation of the behavioral and lifestyle modifications necessary to combat chronic diseases. The means for implementing these preventive services may be considerably facilitated through the use of the Internet and personal communication devices. As discussed above, HAs have been effective in facilitating behavior change when coupled with a feedback support system. Embodiments consistent with the present invention may use the Internet and personal communication devices to provide the patient with pre-programmed algorithms, individually tailored for health care provider-to-patient feedback based on the patient's behavior and responses.

For example, patients who indicate that they regularly engage in moderate physical activity may get feedback that offers positive reinforcement. Alternatively, patients who do little physical activity may get a feedback with suggestions for how to gradually incorporate physical activity into their lifestyle.

Embodiments consistent with the present invention may integrate personal communication devices with other medical devices and biosensors, thereby providing: (1) tracking of subjective and objective data, including data on physical activity levels of the patient; (2) comparing this datum to predetermined goals; and (3) providing real-time feedback of actions the patient should take and to provide encourage for the patient to reach the predetermined goals.

Embodiments consistent with the present invention may use health analysis algorithms to create a new standard of care for patients with chronic diseases such as, but not limited to: asthma, diabetes, obesity, heart disease. For example, such algorithms may provide a personalized evaluation of the overall chronic disease management of a patient by including measurement of blood glucose readings, blood pressure, lipids, exercise, and nutrition. In addition, such embodiments may target personal changes in behavior to maintain improved health. That is, embodiments consistent with the present invention may provide a health risk assessment, with the focus not only on preventing a disease, but also preventing complications associated with a disease.

One embodiment consistent with the present invention may provide a chronic disease management system, comprising a portable chronic disease management application that installs on a patient's personal communication device and empowers the patient to better manage their chronic disease. The portable chronic disease management application may convert the patient's personal communication device into a dynamic health interface to their health care providers. In addition, the portable disease management application may be updated regularly by the care provider using a disease management server application. The system may also comprise a disease management server application further including a content management subsystem, algorithm subsystems, personalization subsystems, and a communications subsystem. The portable chronic disease management applications may be ported or downloaded to the personal communication devices in accordance with a patient's profile to provide a personalized preventive treatment action plan.

In another embodiment, a method for chronic disease management is provided, that starts with a health care provider defining a patient profile in the server application. Once a personal communication device is identified with a patient, multimedia applications will be transferred by the communication subsystem to the personal communication device in accordance with the patient's profile. Each time there is an interaction between the personal communication device and the chronic disease server, the communications system will make sure that the personal communication device will get its needed updates (based on content/algorithms changes which impact this profile and marked for download). In addition, communication messages with other systems/devices as required by the patient's profile will be performed.

Yet another embodiment provides a method for chronic disease management that:
manages the overall status of chronic diseases (e.g., diabetes, asthma, obesity) and assigns an appropriate action plan for patients and physicians based on the patient's individualized health risks and status in the SOC;
provides real-time electronic and call center support to patients with the frequency and intensity of patient interaction based on a patient's health risk and disease status;
provides a patient with reminders and incentives for improved chronic disease control;
provides comprehensive long term chronic disease management by establishing a closer relationship between the patient and health care providers (e.g., primary care physician, diabetes educator, nephrologists, cardiologists, ophthalmologists, etc) by utilizing and integrating the health assessments of the various health care providers into a coherent action plan; and
provides real-time feedback to patients via cell phone or other communication devices on all aspects of the patient's chronic disease care and continues to promote behavioral change and lifestyle modification.

The disclosed embodiments may provide a support system for both patients and physicians by improving the monitoring of a patient's health status and preventing further deterioration of the patient through chronic disease management. In particular, the embodiments may use an evidence-based, quality control assessment based on standards set forth by the governing bodies for objective data related to a patient's cholesterol, hypertension, diabetes, kidney disease and integrates this objective data into a dynamic, personalized action plan from the cumulative reporting of the patient's health care team (e.g., primary care physician, diabetes educator, cardiologist, nephrologists, nutritionists, endocrinologist, etc.).

Another embodiment provides a method for health assessments, comprising:
collecting subjective and objective patient data from multiple sources (e.g., physician's visit notes, lab results, patient's information) via multiple means of communication (e.g., direct input into web based database, wireless data transmission, data gathering over cell phones etc.);
storing data on a server
analyzing data by comparing to standard reference value for the data from governing bodies;
providing feedback on disease management to the patient's cell phone and additional information to health care providers and relatives;
generating text messages out of obtained values for summary log book data sheets;
grading of overall disease management, including health care provider performance and patients disease management;
composing action plans by integrating all available information, flagging of items that need no attention, retests or immediate action;
assessing the patients readiness to change through the SOC model and providing interactive means to change the patients behavior through the 5 A's.

The disclosed embodiments may provide for chronic disease management through a real-time, interactive, comprehensive HAs.

Embodiments consistent with the present invention may utilize objective and subjective data collected from a patient to develop and design individualized treatment intervention action plans for chronic diseases, and to provide a practical implementation of the Health Assessment (HA) and Stages-of-Change (SOC) models within the “5A's” model. In addition, the disclosed embodiments may implement this combination of models in an interactive manner through the use of the Internet and personal communication devices.

The HA method may provide one component of population-based health improvement strategies. By obtaining and evaluating such objective data as height, weight, blood pressure and cholesterol, the health assessment aspect of the disclosed embodiments may provide practical application of preventive services.

HAs are an important component of health improvements based on behavioral change and lifestyle modification strategies. Thus, obtaining and evaluating such objective data as height, weight, blood glucose level, blood pressure, and cholesterol via HAs are invaluable in the practical application of preventive services.

However, in addition to the objective parameters obtained through HAs, disclosed embodiments may consider the patient's readiness for change, in order to fully understand an individual's health state and to design an appropriate and tailored plan of care. The SOC model conceptualizes the process of intentional behavior change. For most persons, the SOC model assumes a change in behavior occurs gradually. That is, most patients make a behavioral change by moving through the following stages: (1) being uninterested, unaware or unwilling to make a change (i.e., pre-contemplation stage); (2) to considering a change (i.e., contemplation stage); and (3) to finally deciding and preparing to make a change. Simple “stage-based” approaches derived from the SOC model have demonstrated widespread utility and effectiveness. By identifying a patient's stage/position in the SOC process, health care providers can tailor their intervention for chronic disease prevention and treatment to enhance the patient's progression between stages.

In addition, to the HA and SOC model discussed above, the “5As” model is applied to deliver evidence-based behavioral changes. The disclosed embodiments may assist in overcoming the difficulties in consistently delivering the benefits of lifestyle modifications in a practical form within the context of primary healthcare through the “5 A's” model.

Specifically, the “5A's” model entails: (1) assessing the behavioral risk factors; (2) advising the patient about personal health risks and benefits of behavioral change; (3) agreeing on treatments goals and methods in consultation with the patient and other healthcare professionals; (4) assisting individuals by providing techniques that support behavioral change and medical treatment, as appropriate; and (5) arranging follow-up visits, additional health assessments and support. More details on the elements of the “5A's” model are discussed in the paragraphs below.

Assessing: Health care providers will ask patients to complete and transmit computerized questionnaires or log books, either via the Internet or radio-telephone based, before an office visit. At the office, only objective measurements (e.g., weight, height, BP etc.) will be obtained. The data from each source will be fused and analyzed by a computer system.

Advising: By the time patients see the health care provider, a computerized feedback form will be provided separately for both the patient and the health care provider, highlighting the most important information and points for discussion during the visit.

Agreeing: The actual encounter between patient and health care provider can now be conducted in a time efficient manner. The computerized feedback form will be discussed, followed by a goal setting process.

Arranging: A proposed treatment regimen, along with short-term and long-term goals may be recorded in the computer system and the patient may obtain a printout and electronic copy of a personally tailored action plan and the date of the next office visit.

Assisting: Between visits, the patient may receive (e.g., via voice mail, e-mail, text messages) personal reminders, encouragement and advice sent directly to their radio telephones or other electronic communication devices (e.g., personal digital assistant, iPods, personal computers, etc.).

In addition, through multimedia applications, a menu of video tutorials on the specific health issues and risk factors addressed by their personal action plans may be added to a treatment regimen that may be sent directly to the patient's cell phones or other communication devices. Further, additional health assessments may be conducted to look for changes in both subjective and objective data in between office visits. Moreover, patients may receive reminders about their next visit and may have the possibility of sending questions they would like to discuss with their healthcare provider before or during their next visit.

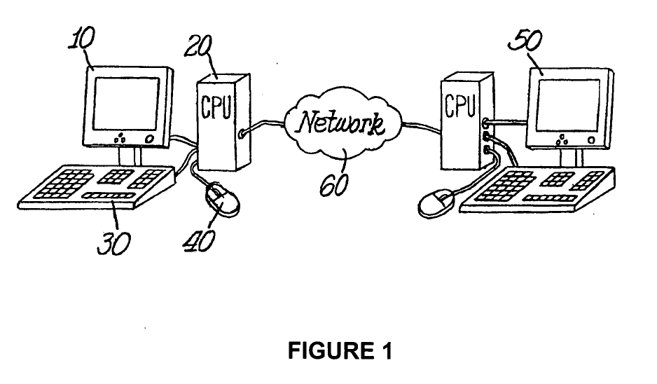

FIG. 1 shows a non-limiting example of an embodiment consistent with the present invention where the patient's subjective/objective data (e.g., responses to a questionnaire) can be ported/outputted/uploaded from a patients personal communications device 20 (i.e., a personal computer 15 in this example) to a chronic disease application server 50 via a communication network 60. The patient's responses may be input and shown on the monitor 10, heard on a speaker, or presented on another output device (not shown) that may be connected to the patient's personal communication device 20. The patient's data may be inputted by the patient via a keyboard 30, mouse 40, or touch screen display 10 of the personal communication device 20, as shown in FIG. 1. Next, the patient's inputs may be uploaded through a communication network 60 that is at least one of a direct communications connection, wireless communications connection, local area network (LAN), or the Internet. Examples of direct communications include, but are not limited to: oral, written, and wired telephone communication. Examples of wireless communications include but are not limited to: radio and cellular telephones. In addition, other input devices, such as a microphone or touch screen panel, may be used to input the patient's responses.

The patient's data may also be analyzed in personal communication device 20 and/or can be transmitted to a computer 55 of chronic disease management server 50 for analysis. Computers 15 and 55 at least include a microprocessor, memory, input devices, and output devices. Computers 20, 50 may also include a monitor or other display/output devices for display that are available to healthcare providers. Further, instructions regarding suggested treatment options are also presented to the patient or health care provider on their respective monitors or other display/output devices.

Alternatively, the patient's inputs can be recorded on a diskette, compact flash or other portable media, by device 20 and the media can be physically transported to healthcare providers if necessary for further analysis on computer 55 of the chronic disease management server 50 and displayed on a monitor 65 or other display/output device local to the healthcare provider. This interaction between patient and healthcare providers may occur within the confines of the healthcare provider's office or remotely through communication network 60 as shown in FIG. 1. Access to the computers and communication system of the system of FIG. 1 by either the patient or healthcare providers can also be provided by using a password in order to ensure the privacy and security of the patient and his/her health information.

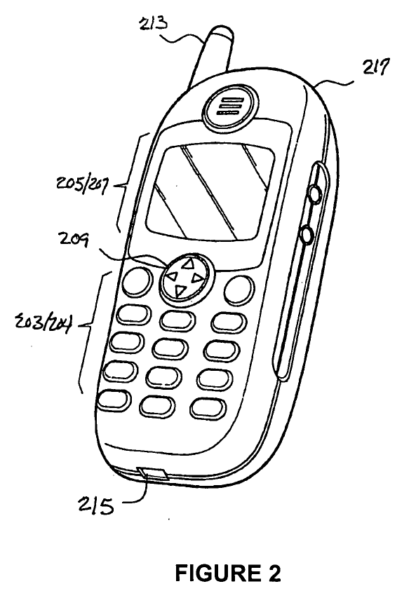

FIG. 2 illustrates another exemplary personal communication device, in the form of a cell phone 200 that may be integrated into the system and methods of the present invention. As shown in FIG. 2, cell phone 200 may provide an alphanumeric keypad 203/204; a display/input window 205/207; a cursor control 209; a first communication port 213; and a second communication port 215. Cell phone 200 includes a processor (not shown) including an operating system such as Windows Mobile, BREW, Java II Micro Editor (J2 ME), etc. The operating system permits execution of application programs, to be described below in greater detail. The descriptions for the operation of personal computer 15 of FIG. 1 are applicable to analogous elements of FIG. 2.

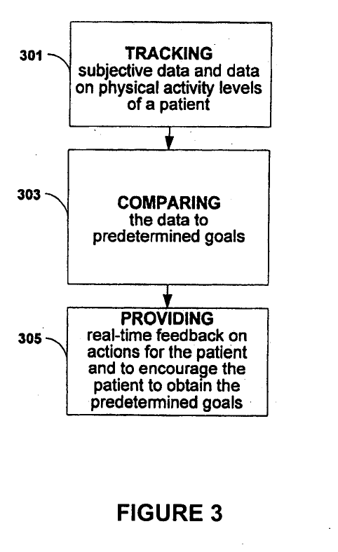

FIG. 3 is a flow diagram of an exemplary embodiment consistent with the present invention. In step 301 of FIG. 3, subjective data and objective data are collected from the patient. Step 303 involves comparing and analyzing both sets of data to determine their compliance with predetermined goals related to the management of a chronic disease. In light of the results of the comparison and analysis, real-time feedback on actions to be taken by the patient to meet the predetermined goals as well as messages and information to encourage the patient is provided in step 305.

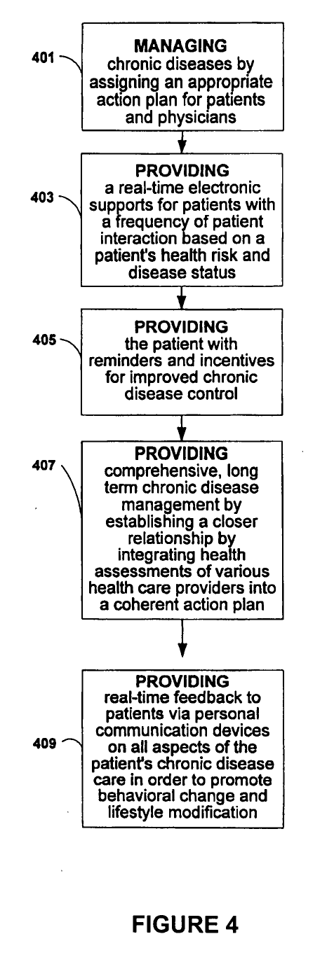

FIG. 4 illustrates another embodiment of a method for chronic disease management. In step 401, the overall status of chronic diseases (e.g., diabetes, asthma, obesity) may be managed by assigning an appropriate action plan for patients and physicians, based on the patient's individualized health risks and status in the SOC. Real-time electronic and call center support maybe provided to patients, with the frequency and intensity of patient interactions based on a patient's health risk and disease status in step 403. Step 405 provides the patient with reminders and incentives for improved chronic disease control. A comprehensive long term chronic disease management maybe provided to the patient by establishing a closer relationship between the patient and health care providers (e.g., primary care physician, diabetes educator, nephrologists, cardiologists, ophthalmologists, etc) by utilizing and integrating health assessments of various health care providers into a coherent action plan in step 407. Step 408 provides real-time feedback to patients via cell phone or other personal communication devices on all aspects of the patient's chronic disease care and continues to promote behavioral change and lifestyle modification.

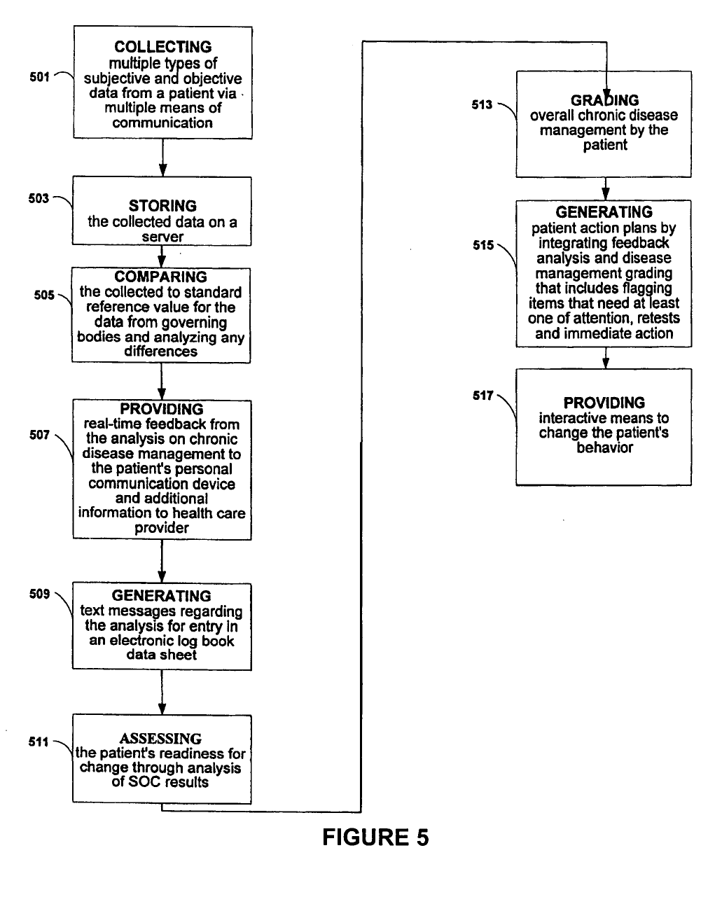

FIG. 5 illustrates an exemplary flow diagram of an embodiment of a method for health assessments, consistent with the present invention. Step 501 of FIG. 5 is directed to collecting subjective and objective patient data for health assessments from multiple sources (e.g., physician's visit notes, lab results, patient's information) via multiple means of communication (e.g., direct input into a web based database, wireless data transmission, data gathering from personal communication devices). Storing the collected data on a chronic disease management server is performed in step 503. In step 505, the collected data is analyzed by at least comparing the collected data to standard reference values for good health with respect to specific diseases that is provided from governing bodies. As a result of the analysis, feedback on chronic disease management is provided to the patient's personal communication device and additional information is provided to health care providers in step 507. In step 509, text messages are generated from the data values and analysis for entry into electronic summary log book data sheets. In step 51 1, the patients readiness to change is assessed through the SOC model and providing interactive means to change the patients behavior through the 5 A's. Grading of overall disease management, including health care provider and patient's performance in terms of disease management occurs in step 513. Generating patient action plans by integrating all available information including flagging of items that need attention, retests, or immediate action is performed in step 515. Interactive means for changing the patient's behavior are provided in step 517.

Yet another embodiment consistent with the present invention is a chronic disease management system, the hardware of which is illustrated in FIG. 1 and FIG. 2, and further comprising at least one portable chronic disease management application that is installed and runs on personal communication device 20 or 200. These applications further empower the patient to better manage their chronic disease. The portable chronic disease management applications may make the patients personal communication device into a dynamic health interface to their health care providers. In addition, the portable disease management applications may be updated regularly by the care provider from the chronic disease management server using a disease management server application.

For example, an embodiment consistent with the present invention may include a disease management server application comprising a content management subsystem, an algorithm subsystem, a personalization subsystem, and a communications subsystem. This application may be implemented on chronic disease management server 50 (FIG. 1). The portable chronic disease management application may be ported or downloaded over network 60 to personal communication devices 20, 200 by the chronic disease management server, in accordance with a patient's profile, to provide a personalized preventive treatment action plan.

The content management subsystem may be a server application that manages various types of content for different populations. The content management subsystem may include, but is not limited to: text animations, movies, and links to applications that can be used for patient education and care. The content management subsystem may be tailored to fit a portable communication device such as cell phone 200, but is not so limited.

The content management system may determine what content will be installed on which patient profile. The content management subsystem may install, for example, language-based content, age-based content, disease-type content and gender-based content. The content of the content management subsystem can be modified on an ongoing basis.

A algorithm subsystem may store clinical algorithms for different clinical scenarios of patients with specific types of chronic disease. The algorithm may be a software program and may be available for download to a personal communication device in various versions.

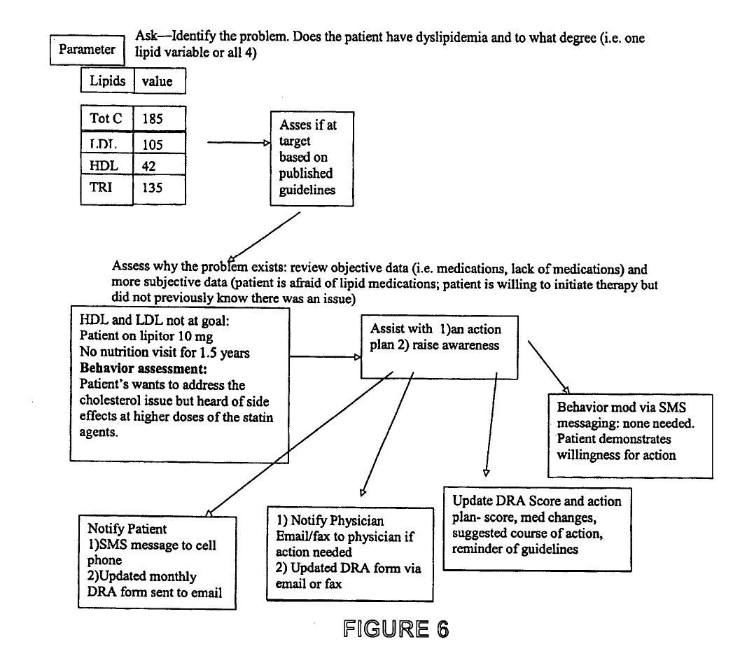

FIG. 6 to FIG. 10 are illustrative examples of algorithms targeting a specific disease. In particular, FIG. 6 to FIG. 8 illustrate some of the steps in data collection and analysis for determining whether a patient has the specific disease of dyslipidemia. In FIG. 6, the problem of diagnosing dyslipidemia is identified and objective data related to lipid values is collected from the patient. An assessment/analysis of the data is also performed to determine whether the patient's objective data values are within a target range based on published guidelines and standards. As a result of the assessment/analysis, it is determined that HDL and LDL for the patient is not within the published guidelines. In addition, a behavioral assessment is included, noting the patient's concerns about certain side effects of the treatment regimen.

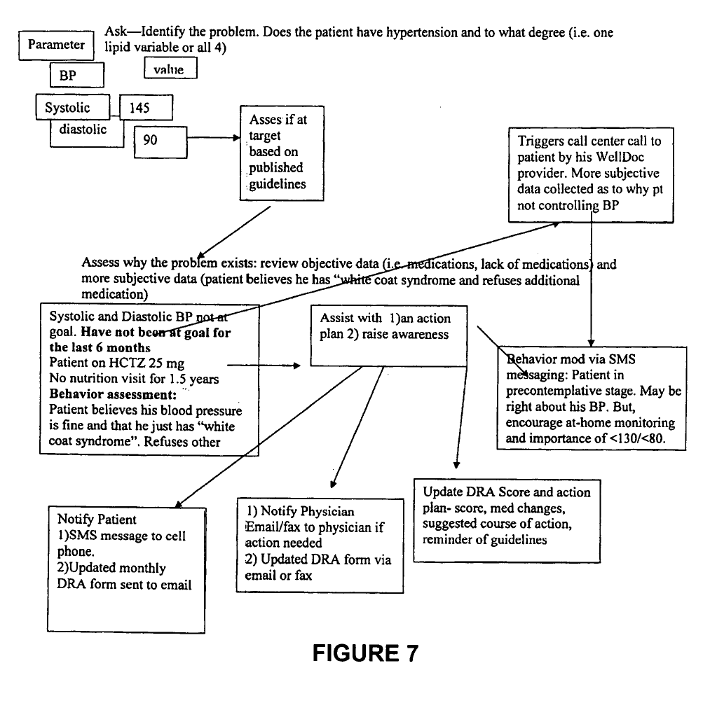

FIG. 7 is an exemplary flow diagram related to the algorithm for assessing why the problem exists. In particular, the patient's concerns/fears regarding the treatment regimen is considered in developing an action plan and raising the patient's awareness of the need for treatment for their illness. In order to carry out the action plan, FIG. 7 suggests: (1) notifying the patient through: (a) SMS messages to their personal communication device; and (b) sending a monthly DRA form that is to be updated; (2) notifying the physician via e-mail/fax when action is needed; and updating the DRA form via e-mail/fax.; (3) Updating the DRA Score and Action Plan score regarding: medication changes, suggested course of action; and reminder guidelines.

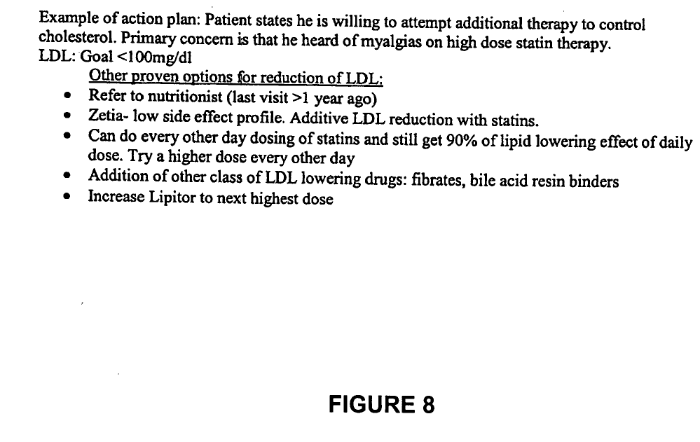

FIG. 8 is an exemplary diagram presenting a personalized Action Plan consistent the present invention. In the personalized Action Plan of FIG. 8, the patient's willingness to attempt to change and their concerns about the treatment regimen are both noted. A suggested goal of the action plan (i.e., LDL<100 mg/dl is indicated. In addition, the Action Plan includes other proven options for reduction of LDL such as, but not limited to: visiting a nutritionist; additional of other classes of LDL lowering drugs (e.g., fibrates, bile acid resin binders); and increasing Lipitor the next highest suggested dosage.

The communications subsystem may provide means of communication to personal communication devices 20, 200. The communication subsystem may receive updates from devices 20, 200 and then update the patient profile on the server and send back updates to the patient profile on the personal communication device. It may control all downloads and upgrades and will log the occurrence of such events. This system may also be responsible for communicating messages with other systems/devices, if required by patient profile.

The Personalization subsystem may allow the care provider (e.g., doctor, case manager etc.) to define and modify the patient profile. The patient profile is the entity in the system that will determine which applications will be installed on the patient's personal communications device and which updates the personal communication device will receive and when it will receive them. The patient profile may include: (1) demographic data, such as: age, gender, language, education level etc; (2) clinical parameters, such as: disease type (e.g., type 1 diabetes), treatment plan (e.g., sliding scale) etc.; (3) communication parameters, such as: message update rate; medical alert criteria, provider messages etc.; and (4) an application that tracks patient progress on an action plan and assists the provider (e.g., with on-line or printed reports) to modify the patient profile.

The Internet, cell phones, portable personal computers, personal digital assistants, and personal entertainment devices are ubiquitous in modern life. In particular, these portable communication devices are often carried by many individuals virtually twenty-four hours a day. The cell phone in particular may be used in applying portable, real-time health care solutions. In the United States alone, the number of cell phone subscribers reached approximately 159 million in 2003.

The integration of personal communication devices (e.g., cell phones) with new biosensors (e.g., heart rate monitors) and the availability of medical devices (e.g., glucose meters) that can communicate with these devices further promotes the potential for the use of these devices in a personal communication device-based chronic disease management system for use in the collection of objective data. The application of these technologies to diabetes care is discussed below as a non-limiting example of how chronic disease management and health assessment and management may be improved by their use.

The frequency of diabetes is dramatically rising all over the world. Whereas in 2000, there were 171 million people with diabetes worldwide, this figure is expected to more than double by the year 2030. In order to be well managed, diabetes is a disease that requires intricate data collection and processing as well as good communication between physician and patient.

However, in the process of managing diabetes, there is much room for error. Though background art diabetes management assistance programs based on computer, Internet, or personal digital assistant (PDA) based have been proven to be helpful in the management of diabetes, real-time management has been problematic.

In contrast to background art approaches that simply track blood glucose readings over time, embodiments consistent with the present invention may track and analyze several critical factors for effective diabetes disease management, as well as factors related to readiness to modify behavior. Though high blood glucose associated with diabetes leads to complications (e.g., of the kidney, eye, and nerve disease), high blood glucose is not the only critical factor in diabetes disease management. Uncontrolled blood pressure and lipids, in the presence of diabetes, are additional critical factors and are often the factors responsible for the high mortality rate associated with the disease.

Thus, the critical factors with regards to the chronic disease management with a patient with diabetes are: (1) lipids; (2) blood pressure; (3) annual screening for micro-vascular complications (i.e., nerve diseases); (4) stages-of-change status in connection with the ability to implement lifestyle modifications; and last but not least, (5) blood glucose levels. Embodiments consistent with the present invention may consider all of the above in order to provide a complete health assessment of a patient's current state of health and to determine how that patient perceives their own current state of health.

As noted above, another component for health assessment and disease management is taking a patient's needs into account. That is, generic feedback at generic intervals does not make a significant long-term impact in the patient's ability to make lifestyle modifications and maintain good health. Instead of the generic feedback approach of the background art, embodiments consistent with the present invention may provide personalized feedback by collecting patient data to assess the patient's individual status in a stages-of-change (SOC) model and may help patients make these changes by presenting them with a personalized action plan.

In addition, embodiments consistent with the present invention may help the patient make changes, by supporting them with health care providers (e.g., diabetes educators, nutritionist, cardiologist,) available via telephone, Internet chat, or other means of communication.

As a non-limiting example of the concept discussed above, if a patient is diabetic, they may initially speak with a diabetes educator who will collect not only the patient's objective data, but also the very necessary subjective data. Since different patients are non-compliant with carrying out health care provider instructions for different reasons (e.g., non-compliance is often it due to some imagined or real, but surmountable, obstacles), including personalized inputs obtained from the patient by a diabetic educator or as a result of the patient submitting results of a questionnaire electronically, can make it possible to identify many of the obstacles to patient compliance. By using both objective and subjective data, embodiments consistent with the present invention may develop accurate health assessment that personalizes the level and type of medical intervention required.

Embodiments consistent with the present invention may provide patients and health care providers with a regular (e.g. monthly) personalized “system check” relevant to the patient's disease management. Green, orange, or red flags may be used to indicate where preventive action needs to be taken.

Embodiments consistent with the present invention may also include: (1) “Red Flag” algorithms for any electronic medical device (e.g., glucose meter, blood pressure machine; flow rate meter) reading that falls within a designated “critical zone,” so that these events will automatically be flagged; (2) chart-ready data sheets of the patients records on an electronic medical device (e.g., glucose meter; blood pressure machine; flow rate meter) readings; (3) a physical activity monitor with an embedded electronic hardware (e.g., heart rate monitor, accelerometer, pedometer) used to monitor the patient's physical activities; (4) multimedia applications providing a patient with video, text messages or e-mails on numerous subjects related to their chronic diseases (e.g., diabetes, hypertension, asthma); (5) a voice recognition technology-based log book function providing an easy man-machine interface for reporting personal/health data (e.g., blood glucose level, blood pressure, temperature, crab/calorie counting) through a radio telephone or other voice-based communication device; and (6) communication capability for transmitting patient data to a physicians' office or directly to their phone on demand.

Embodiments consistent with the present invention may include simple algorithms that can be directly downloaded through the Internet or other communications means to a patient's cell phone or other communications device in order to provide the capability to trouble shoot a health issue in real-time. The algorithms may also include a clear indication when direct medical attention should be immediately sought by the patient.

Through the use of the Internet and the electronic personal communication devices discussed above, significant barriers in the application of clinical preventive services may be overcome. Most importantly, health care providers and patients will be able to create dynamic, easily accessed documentation that can provide for consistent and thorough health assessments.

The foregoing description illustrates and describes embodiments consistent with the present invention. Additionally, the disclosure shows and describes only certain embodiments, but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described herein above are further intended to explain best modes known of practicing the invention and to enable others skilled in the art to utilize the invention in such, or other, embodiments and with the various modifications required by the particular applications or uses of the invention. Accordingly, the description is not intended to limit the invention to the form or application disclosed herein. Also, it is intended that the appended claims be construed to include alternative embodiments.

### Appendix 1

The Overall objectives include:
1. Improve Patients' Glycemic Control—Patients receive real-time feedback and education to their cell phones with personalized algorithms, alerts, HCP-prescribed insulin directions and continuously updated disease assessments and action plans. HCPs also receive regular feedback regarding patients' glycemic control.
2. Improve Patient Outcomes through Total Diabetes Disease Management—Diabetes goes well beyond glycemic control. The disclosed solution focuses on total disease management including: glycemic control, lipids, blood pressure, microvascular screenings, lifestyle and medication management.
3. Simplify and Support Patient-HCP Interactions—By automating and streamlining the data collection and analysis process, the disclosed solution will be a time-saving tool for patients and HCPs.
4. Increase Patient Compliance and Self-Management Skills Through Behavior Modification—The disclosed solution is being developed to take into consideration an individual patient's needs and skill set within the stages of change model.
5. Lower Systematic Health Insurance Costs—Disclosed solution aims to lower utilization rates by improving patient compliance and outcomes. The solution is modifiable to leverage the existing resources and needs of health insurance carriers and disease management companies.
6. Leverage Cutting Edge and Highly Adopted Technology—Using low cost and reliable solutions that are accessible via the web and cell phones disclosed technology will be able to be widely distributed.
7. Facilitate Collection and Tracking of Clinical Data—Disclosed solution allows health care providers and research institutions an innovative and efficient way to collect and track individual and aggregate clinical data.

### 2.0 Technology Overview

Disclosed solution combines web and cell phone technologies and greatly simplifies the process of BG data collection. The software is designed to be flexible and adaptable for changing and improving technologies. Currently the disclosed solution utilizes Bluetooth technology for wireless transmission from the BG meter to the cellphone. Other embodiments may use an “all-in-one” cell phone with the meter actually housed in the cellphone. Once the BG reading is received by the cell phone, disclosed software analyzes the BG reading utilizing proven diabetes management algorithms and guides the patient in real-time through any required BG treatment steps. The software application is unique in that it may be personalized to the patient and may take into consideration the type of diabetes, socioeconomic background, primary language, insulin regimen, target BG values, education level of the patient, and the patient's readiness to change. The system may combine the BG data with the patients other critical bio-data, including, but not limited to: lipids, blood pressure, microvascular screenings, lifestyle, and current medications to provide patients and HCPs with easy-to-interpret diabetes risk assessment reports at regular intervals. Much of the manual data collection and interpretation that currently is required by patients and HCPs is eliminated-our system does it automatically for them.

### 3.0 Overview of Data Flow

Upon registration for the disclosed software, call center personnel may gather from the patient and his HCP the patient's key medical and behavioral information into the system. This data collected may ensure that feedback and instructions are personalized to the individual patient. Once the BG value is received by the phone, the patient may be prompted by the phone's software to identify the blood sugar (i.e. pre or post prandial, bedtime, snack, feeling ill) and to enter peripheral information. Then, this data is sent to our HIPPA-compliant, password protected, Level III security server, which analyzes the information. Below is an example of the data flow:

Pre-Breakfast Blood Sugar Reading:

Scenario—Patient A has Type 1 diabetes and has just tested his/her blood sugar prior to breakfast.

Result—The blood sugar reading is received by Patient A's cell phone and the patient identifies it as pre-breakfast. The system then prompts the patient to enter the number of carbohydrates in the meal. Using the already programmed, patient-specific, insulin: carbohydrate (LC) ratio and correction factor, Patient A's insulin dose for that meal and corresponding pre-prandial BG is displayed on the phone in real-time.

Conclusion—All of this data is captured and stored in a functional logbook to which both the patient and HCP have access via the web. Monthly, logbook data is sent to the HCP, with trends and BG excursions clearly highlighted. Patients always have access to the most recent two weeks of BG values stored on the patient's phone. Critical BG values can also be sent to pre-designated family members' phones or HCPs. This is especially important for children with diabetes, the geriatric population and those patients with hypoglycemic unawareness.

Patient data will also be monitored by the call center and the software for high-risk behaviors-i.e. fasting blood sugar consistently high for one month, frequent hypoglycemia. Repeated high-risk situations trigger a call from a diabetes educator to the patient and a communication to the HCP. Call center interventions will be based on defined high-risk behaviors and pre-determined time intervals that will minimize call center utilization and maximize the effectiveness of the intervention (i.e. call too much and patients will become frustrated; do not call enough and patients may feel unsupported).

### 4.0 Diabetes Management Issues Addressed by the Supplier

There are an estimated 21 million people with diabetes in the US, yet there are only approximately 4,000 endocrinologists. This 5250:1 endocrinologist to diabetic ratio means that there is an increasing burden on primary care doctors to manage their patients' diabetes. Studies have documented the difficulty primary care physicians have with diabetes treatment goals, such as annual eye exams and HbAlc tests and have demonstrated that suboptimal data management by the physician remains a key issue in the quality of care gap in diabetes¹. Problem areas include:
¹ Brown J B, Nichols G A, Perry A. The burden of treatment failure in type 2 diabetes. Diabetes Care 28(3):761-2,2005.

Problem 1: Basic Data Collection—Patients often do not keep a logbook and even when they do, BG logs can be incomplete, illegible, forgotten, lost, or uninterpretable. This makes it difficult for HCPs to make meaningful treatment adjustments.

Response—At a minimum, the system may automatically capture the time and value of a BG whenever the patient tests it. The patient does no more than check his blood sugar and pull out the strip. The patient is then guided in real-time through the collection of peripheral data-how many grams of carbohydrates, pre or post prandial, etc. All of this data is captured and organized in a logical, simple logbook that is stored on the web. The logbook, with concise evaluations of trends and number of severe BG readings, is sent automatically to the HCP monthly via fax or email.

Problem 2: Insulin Dosing—It is difficult for patients to remember how much insulin to give themselves at different times of the day. Patients often forget what their BG targets should be and do not recognize that they may need their insulin adjusted.

Response—As part of the registration process, a patient's insulin instructions and BG targets will be collected from the patient and HCPs office and will be entered into the system by the call center. Anytime the patient's insulin instructions are adjusted, the system will update the patient's health record and display the new instructions on the patient's phone. Below is an example of a Type 1 patient's I:C ratio for a pre-breakfast reading:

[image]

Problem 3: Management of Critical Hyper and Hypoglycemia—BG levels that reach critical levels at either the high or low end of the spectrum can be frightening to patients and pose serious health threats. Patients often over-treat hypoglycemia and may under-treat or under-appreciate a high BG value.

Response—Critical values may be immediately flagged on the cell phone and the patient may be prompted with a real-time action plan such as the 15-15 rule for hypoglycemia. Foods/drinks with 15 grams of carbohydrates are listed and the patient is reminded to retest in 15 minutes. Additionally, a patient may have chosen for all critical values to be sent to a family member via SMS messaging. This is especially important for those patients with hypoglycemic unawareness. The phone may automatically call the patient at pre-determined intervals to remind him/her to retest the BG to ensure that it is normalizing (i.e. the phone will ring 15 minutes after a low blood sugar with a message to retest).

Problem 4: Chronic BG Interpretation and Management—Often only critical BG values grab the patient's attention. Many patients with diabetes are not aware of their target values and their long-term BG trends.

Response—Every month, the software may analyze the trends of the patient's BG values and sends a Short Message Service (SMS) message to the patient about any issues that should be addressed and encourages the patient to call the HCP. An email or fax may also be sent to the HCP alerting him or her about any unfavorable BG trends that may need an attention.

Problem 5: Diabetes Is More Than Glycemic Control—The micro and macrovascular complications of diabetes are a result of the individual and synergistic effects of uncontrolled blood glucose, cholesterol, blood pressure and poor lifestyle (i.e. tobacco use, weight gain, sedentary lifestyle).

Response—the system provides a surveillance and feedback system for patients and HCPs that is a total disease management platform. This feedback is designed to support and facilitate the patient-HCP relationship. We have found that many people with diabetes do not understand the importance of lipids or blood pressure on their overall disease management; HCPs may not be aware of the latest guidelines. At appropriate intervals, both patients and HCPs may be sent reports of the status of the patient's diabetes that include all of the key components of diabetes care. This report is a succinct document that reminds patients and HCPs of all variables, goals, and proposed action plans. It may be sent via fax or email. HCPs are reminded in a non judgmental and unobtrusive way when recommended screenings are due, what the goals for treatment are, and possible treatment strategies are provided for both. Patients most at risk may receive calls from a diabetes educator to discuss their disease and ways in which to gain greater control over their diabetes. Examples would be a person whose blood pressure consistently greater than target or a patient who was gaining weight.

Problem 6: Improving Self-Management Skills and Lifestyle Choices—The self-management responsibilities of diabetes can be overwhelming and many people with diabetes are not always psychologically ready or willing to engage in their self-care or lifestyle modification to the degree that is necessary to effect change.

Response—Many diabetes education programs are designed as if all participants are at the “action” phase of the transtheoretical model of change. This model describes the stages of change through which a person moves through from the pre-contemplative (“I am not ready to change”) to the action phase (“I am ready and willing”). This model has been used successfully in such disease management programs as smoking cessation, diet compliance, and diabetes self-management skills^{2,3}. The system may take into account patients' stage of change (from information gathered during registration and any subsequent call center calls) with regard to several key self-management skills. The system may promote compliance while working within the framework of the patient's readiness to change. The system may also provide incentives reward patients for increased compliance.
² Prochaska J O, Velicer W F, Rossi J S, Goldstein M G, Marcus B H, Rakowski W, Fiore C, Harlow L L, Redding C A, Rosenbloom D, Rossi S: Stages of change and decisional balance for 12 problem behaviors. Health Psychol 13: 39-46, 1994.

³ Jones H, Edwards L, Vallis T M, Ruggiero L, Rossi S R, Rossi J S, Greene G, Prochaska J O, Zinman B. Changes in Diabetes Self-Care Behaviors Make a Difference in Glycemic Control: The Diabetes Stages of Change (DiSC) study. Diabetes Care 26:732-737, 2003.

Problem 7: Diabetes goes beyond Type 1 and Type 2 diabetes—Within the broad categories of diabetes there is a wide variability of the disease state and subsequently different treatment algorithms. For example, someone with type 2 diabetes on intensive insulin therapy is very different than someone with type 2 diabetes on oral medications. Additionally a man with type 1 diabetes is different than a pregnant woman with type I diabetes.

Response—The software may include algorithms that will serve the many different types of patients who have the disease. Examples of the “subcategories” include: type 1 diabetes on an insulin pump, type 1 on intensive therapy, type 1 with poor self-management skills (i.e does not know how to carbohydrate count, test ketones, etc), gestational diabetes, type 2 on oral therapy, etc. as additional unique needs of these populations are determined, they may be incorporated into the system.

### 5.0 Web-Site Support and Functionality

The website may be HIPPA-compliant and password protected. Patients and HCPs can access data whenever they choose. The website may serve as an education resource for patients and a disease management center for patients and HCPs.

In other embodiments, patients may:
View their glucose readings and other health information (e.g., medications, diet, exercise, etc.)
View their current Diabetes Risk Assessment Report
Access their reward center to view and claim earned incentives.
Download self-guided educational programs to influence self-care behaviors Ask questions of the disclosed staff and/or their HCP
Receive their messages in English or Spanish

Health Care Providers may:
Register patient data, update medications, medical history, etc
View patient summary reports including analysis of disease state to facilitate clinical encounters
View reports that evaluate population outcomes and quality of care for all of their patients who utilize the system
Receive alerts on patients who are non-compliant, out-of-control, and/or in need of intervention
Answer or create messages for patients
All web activity and usage is optional for patients and HCPs.

### Appendix 2: Additional Detailed Description

A. Design of Similarity LEAST Squares (SLS) for Prediction of Blood Glucose Level (BG) in Diabetic Patients

The goal is to optimize prediction of BG level for each patient with the simplest most efficient computational model (minimal adequate complexity, MAC) incorporating all available relevant information, eg, dosing, diet/carb's, activity, demographics, lab/clinical metrics, recent levels of measurable chemicals (BG, ketones), and historical time profiles.

Statistical methods known as time series analysis and/or state-space models are required to address this problem, as it is dominated by sequential events and time profiles that depend on estimated processes and metrics. Such methods include ARIMA (auto-regressive-integrated-moving average) models, harmonic models (wavelets), Kalman filter, Markov processes (hidden), and sequence score matrices used in DNA-matching problems. Modifications/combo's of these techniques can produce very “smart” prediction devices. Note that a combination of these methods inside a signal-processing network provided the only known prospective prediction of the economic “timing point” in August, 1982, now recognized as a major event in US economic history. Nevertheless, these methods would have difficulty efficiently modeling the a periodic nature of diabetic time profiles punctuated by gaps of missing and/or estimated information. But, this is the sort of pattern analysis that is done all the time in the human mind. In fact endocrinologists deal with such problems routinely. What is needed is a computational mimic of these experts at the simplest level (MAC) and based on established statistical principles. The SMILES system (SLS) is such an approach as modified to model sequential events.

The SLS method uses experts in the medical field to define/design similarity. By pattern analysis SLS then identifies key features and constructs a model optimized for prospective prediction.

Problem Definition

BG level depends on many known factors both chronic and acute over time. (arrows “→” symbolize “used to impact”)

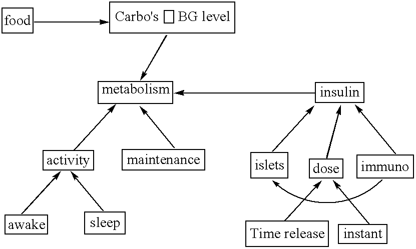

Factors:

Food intake increases BG depending on menu.

Insulin controls BG metabolism, and the dose impact on insulin level can be approximated via kinetics.

The natural production and impact of insulin is not exactly known except that it is inadequate. Metabolism uses up BG via insulin and depends on activity, which is variable.

SLS Design

To capture current info and history important to BG prediction, the pattern vector should contain current and most recent info, maybe 2nd most recent info. Hence, similarity is based on relative time intervals versus absolute. The activity metric and food composition inherently capture “time-of-day” specific to each patient.

In addition model prediction errors (observed-predicted) provide info on patient non-compliance and/or errors in the metric levels versus the true levels (unknown). SLS Vector of metrics

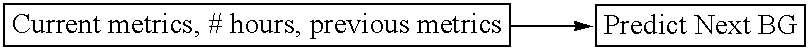

We claim:

1. A method for managing a chronic disease in a patient, comprising:
receiving first data and second data at a patient communication terminal, the first data being representative of the patient's physical condition and the second data being representative of the patient's readiness to modify behavior;
transmitting the first and second data over a communication channel to a disease management server;
generating an output signal at the server representative of a disease treatment action based on the first and second data;
transmitting the output signal over the communication channel to the patient communication terminal; and
displaying the output signal at the patient communication terminal.

2. The method of claim 1, wherein the treatment action comprises a plurality of steps for producing behavioral change in the patient.

3. The method of claim 2, wherein the communication channel comprises a wireless channel.

4. A system for managing a chronic disease in a patient, comprising:
a portable wireless terminal, comprising:
an input device for receiving first data representative of the patient's physical condition and second data representative of the patient's readiness to modify behavior;
a first transmitter for transmitting data over a wireless channel;
a first receiver for receiving data over the wireless channel;
an output device for displaying data to a user; and
a software component for commanding the first transmitter to transmit the first and second data over the wireless channel and for commanding the output device to display data from the first receiver; and
a disease management terminal, comprising:
a second receiver for receiving the first and second data;
a server application that generates an output signal representative of a disease treatment action based on received first and second data; and
a second transmitter for transmitting the output signal over the wireless channel to the portable wireless terminal for display on the output device.

5. The system of claim 4, wherein the disease management server transmits the output signal to a third party, based on the treatment action.

6. The system of claim 4, wherein the server application comprises:
a content management subsystem;
an algorithm subsystem;
a personalization subsystem, and a communications subsystem.

7. The system of claim 4, wherein the server application stores the first and second data.

8. The system of claim 7, wherein the server application stores at least the first data into electronic summary log book data sheets.

9. The system of claim 6, wherein the content management subsystem determines the content to be installed on the portable wireless terminal.

10. The system of claim 4, wherein the server application determines the need for updates of the portable wireless terminal based on content or algorithm changes which impact a patient profile.

11. The system of claim 6, wherein the personalization subsystem generates a patient profile and receives third party commands to modify the patient profile.

12. The system of claim 6, wherein the communication subsystem transmits content to the portable wireless terminal.

13. The system of claim 12, wherein the content comprises multimedia applications.

14. The system of claim 4, wherein the disease management server receives first and second data from patient.

15. The system of claim 4, wherein the disease management server receives the first and second data from a third party.

16. The system of claim 4, wherein the disease management server transmits the output signal to the portable wireless terminal, based on the treatment action.

17. The system of claim 16, wherein the output signal comprises at least one of reminder messages or incentive messages.

18. The system of claim 16, wherein the output signal comprises feedback messages.

19. The system of claim 5, wherein the third party comprises a health care provider.

20. A portable terminal for managing a chronic disease of a patient, comprising:
an input device for receiving first data, representative of physical condition of the patient, and second data, representative of readiness of the patient to modify behavior;
a transmitter for transmitting the first and second data over a first wireless channel;
a processor;
a memory device containing instructions for an application;
a receiver for receiving, over the first wireless channel, output signals generated on the basis of the first and second data; and
an output device for displaying the output signals to the patient.

21. The system of claim 20, wherein the input device is configured to receive the first data from medical devices through a second wireless channel.

22. The system of claim 20, wherein the input device is configured to receive the first data via direct entry by the patient.

23. The system of claim 20, wherein the input device is configured to receive the first data from a third party.

24. The system of claim 20, wherein the application generates data for display on the output device based on the received output signals.

25. The system of claim 24, wherein the application generates data for display on the output device output signal comprising at least one of reminder messages or incentive messages.

26. The system of claim 24, wherein the transmitter transmits the output signal to a third party.
